(19) United States
(12) Patent Application Publication
(10) Pub. No.: US 2005/0180125 A1
(43) Pub. Date: Aug. 18, 2005

(54) Lollipop stick

(76) Inventor: Kuang-Chang Yu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/777,100

(22) Filed: Feb. 13, 2004

(51) Int. Cl. F21K 2/06; F21V 9/16

(52) U.S. Cl. 362/34; 362/84

(57) ABSTRACT

A lollipop stick includes a plastic stick body having a longitudinal receiving cavity formed therein and a fluorescent layer thereof, a breakable airtight tube disposed in the longitudinal receiving cavity and having a first solution contained therein, a second solution contained between the plastic stick body and the breakable airtight tube, and a conjunction structure connects an end of the plastic stick body and being concave-and-convex for combining with esculent sugar cookies. Whereby the breakable airtight tube is fractured while the plastic stick body is bent, the first solution mixed up with the second solution and results into a chemiluminescence reaction by exciting the fluorescent layer thereof.

### BACKGROUND OF THE INVENTION

1. Field of the Invention

The present invention relates to a lollipop stick, and particularly relates to a lollipop stick with chemiluminescence reaction thereof.

2. Background of the Invention

In 1950s, candies are stuffed in a big bag and too difficult to get for little kids. Kids always get their hands sticky with glutinous sugars, and their clothes are getting dirty then, parents are annoyed and impatient about cleaning their hands and clothes. Nevertheless, this kind of situation finally settles due to the candies and sugars with a stick thereof, which is called “lollipop”, the lollipop accordingly becomes the kids' best friend.

Although the lollipop improves the sugar manner for kids, the lollipop adopted with various funs is thirsted for children as time goes by. The sugar industries make sugar cookies and candies with new tastes, fantastic sculptures, or attracting functions for purposes of selling well.

Hence, an improvement over the prior art is required to overcome the disadvantages thereof.

### SUMMARY OF INVENTION

The primary object of the invention is therefore to specify a lollipop stick with chemiluminescence reaction thereof to be fantastic, attractive for kids enjoying all the time.

According to the invention, this object is achieved by a lollipop stick, and the lollipop stick includes a plastic stick body having a longitudinal receiving cavity formed therein and a fluorescent layer thereof, a breakable airtight tube disposed in the longitudinal receiving cavity and having a first solution contained therein, a second solution contained between the plastic stick body and the breakable airtight tube, and a conjunction structure connects an end of the plastic stick body and being concave-and-convex for combining with esculent sugar cookies. Whereby the breakable airtight tube is fractured while the plastic stick body is bent, the first solution mixed up with the second solution and results into a chemiluminescence reaction by exciting the fluorescent layer thereof.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a first embodiment according to a lollipop stick of the present invention;

FIG. 2 is a perspective view of a first embodiment according to a conjunction structure of the present invention; and

FIG. 3 is a perspective view of a second embodiment according to the conjunction structure of the present invention.

### DETAILED DESCRIPTION OF THE EMBODIMENTS

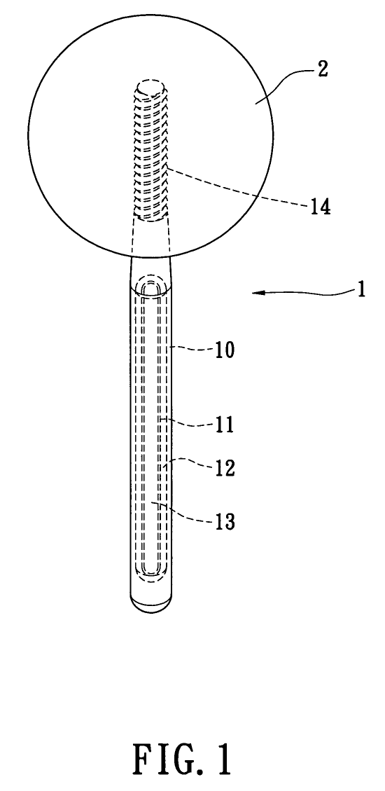

Referring to FIG. 1, the present invention provides a lollipop stick 1, the lollipop stick 1 includes a plastic stick body 10 having a longitudinal receiving cavity formed therein along an axial thereof, a breakable airtight tube 11 disposed in the longitudinal receiving cavity of the plastic stick body 10 and having a first solution 13 contained therein, a second solution 12 contained between the plastic stick body 10 and the breakable airtight tube 11, and a conjunction structure 14 connects an end of the plastic stick body. The plastic stick body 10 is used for kids handling, the conjunction structure 14 is concave-and-convex for combining with esculent sugar cookies 2.

The plastic stick body 10 has a fluorescent layer coating on an interior wall thereof, when the plastic stick body 10 is bent, the breakable airtight tube 11 is fractured accordingly, the first solution 13 flows out to mix up with the second solution 12 and to excite the fluorescent layer then to get a chemiluminescence reaction. Wherein the breakable airtight tube 11 can be made of glasses, the second solution 12 is made of phenyl oxalate ester, the first solution 13 is made of hydrogen peroxide. The chemiluminescence reaction is based on energy transfer between an intermediate formed in the reaction of the phenyl oxalate ester with the hydrogen peroxide, and the reaction intermediate is thought to be C2O2, an unstable molecule, which reacts with a particular molecule to emit photo of chemiluminescence light, when the breakable airtight tube 11 is broke.

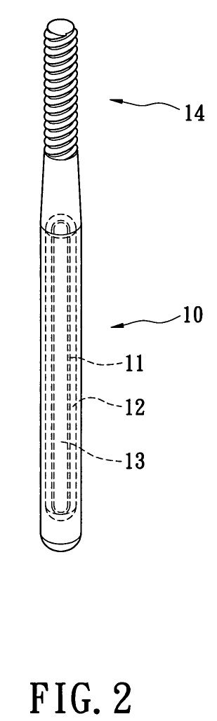

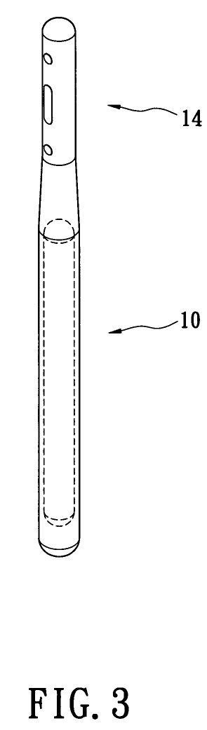

The conjunction structure 14 is concave-and-convex to increase a friction between the conjunction structure 14 and the esculent sugar cookies 2 for combining with esculent sugar cookies 2. With respect to FIG. 1 and the FIG. 2, a first embodiment of the conjunction structure 14 provides at least one recess, and the recess can penetrate through the conjunction structure 14 to be a through hole. Sizes and quantities of the recess or the through hole depend on experience; or see FIG. 3, the conjunction structure 14 is has a screwed thread formed on an exterior surface thereof, and this also increase the friction between the conjunction structure 14 and the esculent sugar cookies 2. Accordingly, the present invention provides a light, fantastic, attractive lollipop stick for kids to enjoy.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A lollipop stick comprising:
a plastic stick body having a longitudinal receiving cavity formed therein and a fluorescent layer coating on an interior wall thereof, and the plastic stick body being used for handling;
a breakable airtight tube disposed in the longitudinal receiving cavity and spaces a predetermined distance from the interior wall of the plastic stick body, the breakable airtight tube having a first solution contained therein;
a second solution contained between the plastic stick body and the breakable airtight tube;
a conjunction structure connects an end of the plastic stick body and being concave-and-convex for combining with esculent sugar cookies;
whereby the breakable airtight tube is fractured while the plastic stick body is bent, the first solution mixed up with the second solution and results into a chemiluminescence reaction by exciting the fluorescent layer thereof.

2. The lollipop stick claimed as claim 1, wherein the breakable airtight tube is made of glasses.

3. The lollipop stick claimed as claim 1, wherein the conjunction structure has a screwed thread formed on an exterior surface thereof.

4. The lollipop stick claimed as claim 1, wherein the conjunction structure has at least one recess formed thereon.

5. The lollipop stick claimed as claim 4, wherein the recess penetrates through the conjunction structure.
